(19) United States
(12) Patent Application Publication
(10) Pub. No.: US 2026/0118594 A1
(43) Pub. Date: Apr. 30, 2026

(54) OPTICAL FIBER CONNECTOR

(71) Applicant: Gloriole Electroptic Technology Corp., Kaohsiung City (TW)

(72) Inventors: Hsien-Hsin HSU, Kaohsiung City (TW); Yu-Cheng CHEN, Kaohsiung City (TW); Yen-Chang LEE, Kaohsiung City (TW)

(21) Appl. No.: 19/003,481

(22) Filed: Dec. 27, 2024

(30) Foreign Application Priority Data
Mar. 11, 2024 (TW) 113202422

(51) Int. Cl. G02B 6/38

(52) U.S. Cl. CPC G02B 6/3838; G02B 6/3826; G02B 6/3869; G02B 6/38875; G02B 6/3893

(57) ABSTRACT

An optical fiber connector includes a main housing, a positioning sleeve, a linking sleeve, and a tail sleeve. The main housing has an insertion end. The positioning sleeve is slidably sleeved on the main housing, and includes a sleeve body portion surrounding the main housing and two protruding portions protruding outwardly from the sleeve body portion. The linking sleeve is sleeved on the positioning sleeve, and surrounds and defines two positioning slots and respectively permitting the protruding portions to extend therein. When the linking sleeve moves away from the insertion end, the positioning sleeve is driven to move away from the insertion end. The tail sleeve is detachably connected to a rear end of the linking sleeve distal from the insertion end. When the tail sleeve is operated to move away from the insertion end, the linking sleeve is driven to move away from the insertion end.

### CROSS-REFERENCE TO RELATED APPLICATION

This application claims priority to Taiwanese Utility Model Patent Application No. 113202422, filed on Mar. 11, 2024, the entire disclosure of which is incorporated by reference herein.

### FIELD

The disclosure relates to a connector, and more particularly to an optical fiber connector that is easy to operate.

### BACKGROUND

Referring to FIG. 1, a conventional multi-fiber push-on (MPO) optical fiber connector 1 includes a ferrule end 11, a main housing 12 sleeved on the ferrule end 11, a positioning sleeve 13 sleeved slidably on the main housing 12, and a tail sleeve 14 connected to a rear end of the main housing 12. The main housing 12 includes a housing wall portion 121, and two protruding rib portions 122 (only one is shown in FIG. 1) respectively located at a left side and a right side of the housing wall portion 121. Each of the protruding rib portions 122 has two inclined outer surfaces 123 facing respectively forwardly and rearwardly. Furthermore, a conventional MPO optical fiber adapter 2 includes a main seat body 21 defining an insertion slot 211, and two engaging hooks 22 projecting outwardly from the main seat body 21. When the optical fiber connector 1 is inserted forwardly into the optical fiber adapter 2, the main housing 12 and the ferrule end 11 gradually slide into the insertion slot 211. During this process, the engaging hooks 22 push the positioning sleeve 13 rearwardly, and the inclined outer surfaces 123 of the protruding rib portions 122 also force the engaging hooks 22 to deform and move away from each other outwardly. After the engaging hooks 22 move past the protruding rib portions 122, the engaging hooks 22 are engaged respectively with the protruding rib portions 122. At this time, the engaging hooks 22 no longer push against the positioning sleeve 13, so the positioning sleeve 13 is biased to return to its original position by springs and surrounds the engaging hooks 22, so that the optical fiber connector 1 is engaged with the optical fiber adapter 2.

Because the positioning sleeve 13 surrounds the engaging hooks 22, even if the tail sleeve 14 is pulled rearwardly so that the engaging hooks 22 may abut against the protruding rib portions 122, the engaging hooks 22 cannot be deformed due to constraint of the positioning sleeve 13. Such design does not allow the engaging hooks 22 to move away from each other outwardly, so that the engaging hooks 22 cannot move past the protruding rib portions 122 in a reverse direction. By virtue of the abovementioned design, the optical fiber connector 1 may be securely engaged with the optical fiber adapter 2 and may not be disengaged by accidental pulling. When it is desired to pull the optical fiber connector 1 out of the optical fiber adapter 2, the positioning sleeve 13 is pulled relative to the main housing 12 toward the tail sleeve 14 so that the positioning sleeve 13 no longer surrounds and constrains the engaging hooks 22, so that the engaging hooks 22 can be deformed and open once again to move past the protruding rib portions 122, thereby allowing the optical fiber connector 1 to be removed from the optical fiber adapter 2.

However, the current trend of disposing optical fiber connectors involves disposing a plurality of optical fiber connectors 1 (and a plurality of optical fiber adapters 2) together in a dense manner, so the optical fiber connectors 1 and the optical fiber adapters 2 are compactly arranged. In such way, a gap between two adjacent ones of the optical fiber connectors 1 in an up-down direction or a left-right direction is small, so it is difficult for a user to insert his/her hand or finger into the gap between the adjacent ones of the optical fiber connectors 1, and it is also difficult for the user to effectively hold the positioning sleeve 13 to perform operations.

### SUMMARY

Therefore, an object of the disclosure is to provide an optical fiber connector that can alleviate at least one of the drawbacks of the prior art.

According to the disclosure, the optical fiber connector includes a main housing, a positioning sleeve, a linking sleeve, and a tail sleeve.

The main housing has an insertion end.

The positioning sleeve is slidably sleeved on the main housing along a plug-in axial direction. The positioning sleeve includes a sleeve body portion surrounding the main housing, and two protruding portions protruding outwardly from the sleeve body portion along a width axial direction that is perpendicular to the plug-in axial direction.

The linking sleeve is sleeved on the positioning sleeve, and surrounds and defines two positioning slots formed along the width axial direction and respectively permitting the protruding portions to extend therein. When the linking sleeve moves away from the insertion end of the main housing in the plug-in axial direction, the positioning sleeve is driven to move away from the insertion end of the main housing.

The tail sleeve is detachably connected to a rear end of the linking sleeve distal from the insertion end of the main housing. When the tail sleeve is operated to move away from the insertion end of the main housing in the plug-in axial direction, the linking sleeve is driven to move away from the insertion end of the main housing.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an exploded perspective view of a conventional MPO optical fiber connector and a conventional MPO optical fiber adapter.

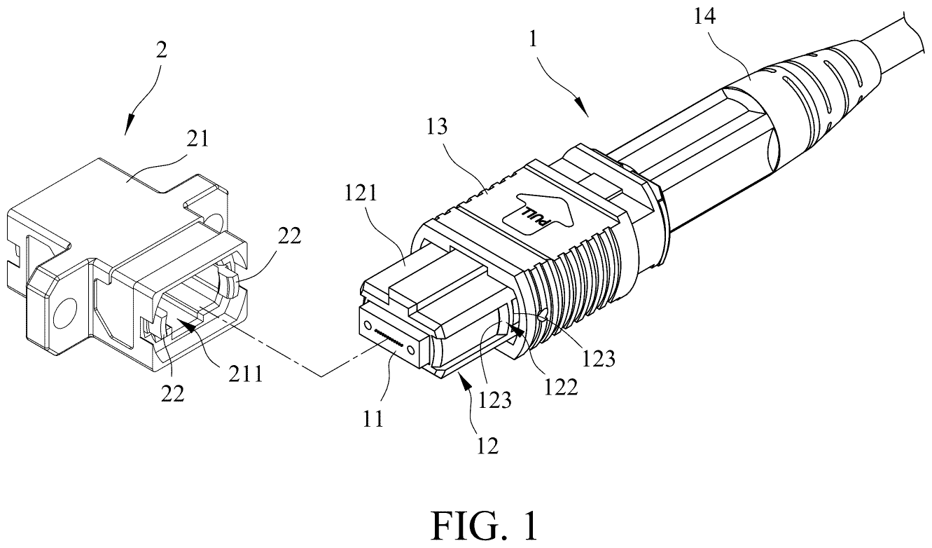

FIG. 2 is a fragmentary perspective view of an embodiment of an optical fiber connector according to the present disclosure.

FIG. 3 is a fragmentary top sectional view of the embodiment.

FIG. 4 is a fragmentary side sectional view of the embodiment.

FIG. 5 is an exploded perspective view of a linking sleeve and a tail sleeve of the embodiment.

FIG. 6 is a schematic top view illustrating the tail sleeve being pulled rearwardly.

FIG. 7 is a schematic side view illustrating the tail sleeve being pulled rearwardly.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

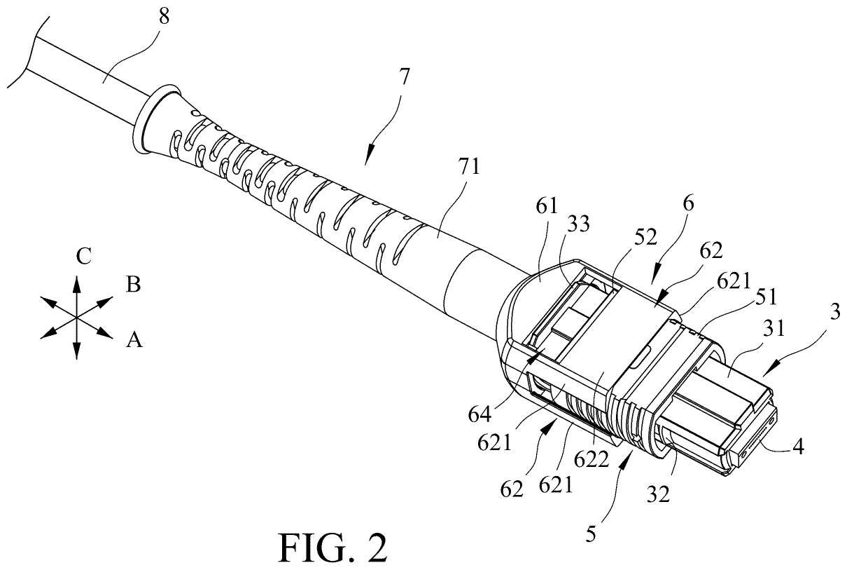

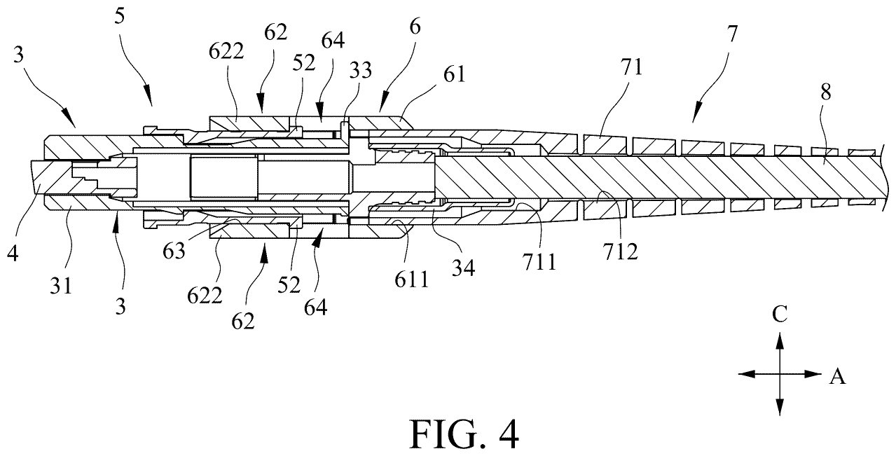

Referring to FIGS. 2, 3 and 4, an embodiment of an optical fiber connector according to the disclosure is shown. The optical fiber connector is a multi-fiber push-on (MPO) optical fiber connector. The optical fiber connector includes a main housing 3 having a front end that serves as an insertion end, a ferrule end 4 disposed in the insertion end of the main housing 3 and protruding forwardly from the main housing 3 in a plug-in axial direction (A), a positioning sleeve 5 slidably sleeved on the main housing 3 along the plug-in axial direction (A), a linking sleeve 6 sleeved on the positioning sleeve 5, a tail sleeve 7 detachably connected to a rear end of the linking sleeve 6 distal from the insertion end of the main housing 3, and an optical fiber cable 8 connected to a rear end of the main housing 3 and extending through the tail sleeve 7 in the plug-in axial direction (A).

The main housing 3 includes a housing body portion 31, two rib portions 32 respectively disposed on two sides of the housing body portion 31 along a length axial direction (B) that is perpendicular to the plug-in axial direction (A), a stopping portion 33 protruding outwardly in a width axial direction (C) that is perpendicular to the plug-in axial direction (A) and the length axial direction (B) from a rear end of the housing body portion 31 distal from the insertion end of the main housing 3, and a rear end portion 34 connected to the rear end of the housing body portion 31 and extending rearwardly away from the insertion end of the main housing 3 along the plug-in axial direction (A).

The positioning sleeve 5 includes a sleeve body portion 51 surrounding the housing body portion 31, and two protruding portions 52 protruding outwardly from a rear end of the sleeve body portion 51 along the width axial direction (C). The stopping portion 33 is located rearwardly of one of the protruding portions 52 along the plug-in axial direction (A). This optical fiber connector further includes two springs 35 disposed between the positioning sleeve 5 and the main housing 3 for storing a resilient restoring force that restores the positioning sleeve 5. Each of the springs 35 has two ends abutting respectively against the positioning sleeve 5 and the main housing 3.

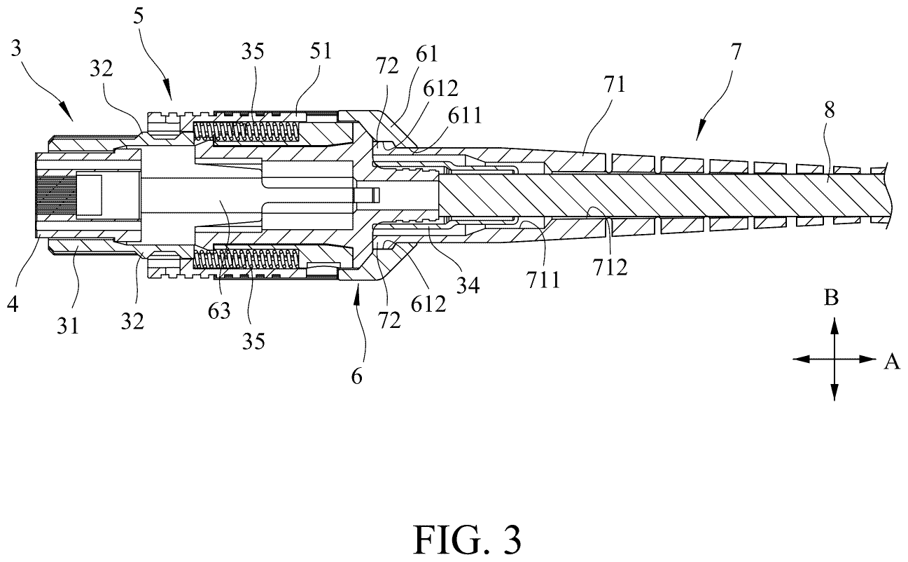

Referring to FIGS. 3, 4, and 5, the linking sleeve 6 includes a sleeve seat 61 located rearwardly of the sleeve body portion 51 and the housing body portion 31 in the plug-in axial direction (A), and two outer housing walls 62 spaced apart from each other in the width axial direction (C) and extending forwardly toward the insertion end of the main housing 3 from the sleeve seat 61 in the plug-in axial direction (A). The sleeve seat 61 and the outer housing walls 62 cooperatively define a sleeve space 63 permitting the positioning sleeve 5 to be disposed therein. The sleeve seat 61 defines an through groove 611 extending along the plug-in axial direction (A) and communicating with the sleeve space 63, and two limiting grooves 612 extending from the through groove 611 away from each other along the length axial direction (B), and recessing rearwardly away from the insertion end of the main housing 3 in the plug-in axial direction (A). Each of the limiting grooves 612 is in spatial communication forwardly with the sleeve space 63 in the plug-in axial direction (A), but does not extend rearwardly through the sleeve seat 61. The through groove 611 permits the rear end portion 34 of the main housing 3 to extend therethrough along the plug-in axial direction (A).

Referring again to FIGS. 2, 3, and 4, each of the outer housing walls 62 includes two side wall portions 621 spaced apart from each other along the length axial direction (B) and extending forwardly from the sleeve seat 61 toward the insertion end of the main housing 3 along the plug-in axial direction (A), and a reinforcing wall portion 622 connected to the side wall portions 621 and located forwardly of one side of a respective one of the protruding portions 52 that is proximate to the insertion end of the main housing 3 along the plug-in axial direction (A). The side wall portions 621 of each of the outer housing walls 62 are respectively located at two sides of the sleeve body portion 51 along the length axial direction (B), and each has a length along the plug-in axial direction (A) shorter than a length of the sleeve body portion 51 along the plug-in axial direction (A). The reinforcing wall portion 622 of each of the outer housing walls 62 is located on an outer side of the sleeve body portion 51 along the width axial direction (C), and has a length in the plug-in axial direction (A) shorter than the length of the sleeve body portion 51 in the plug-in axial direction (A). The side wall portions 621 and the reinforcing wall portion 622 of each of the outer housing walls 62 cooperate with the sleeve seat 61 to define a positioning slot 64 extending along the width axial direction (C) (i.e., the outer housing walls 62 define two positioning slots 64). The positioning slots 64 respectively permit the protruding portions 52 to extend therein. It should be noted that the stopping portion 33 is disposed in one of the positioning slots 64, and is located forwardly of the sleeve seat 61 along the plug-in axial direction (A) (i.e., between one of the protruding portions 52 of the positioning sleeve 5 and the sleeve seat 61).

Each of the side wall portions 621 of one of the outer housing walls 62 is spaced apart from a respective one of the side wall portions 621 of another one of the outer housing walls 62 in the width axial direction (C). Since two side surfaces of the sleeve body portion 51 in the length axial direction (B) are curved surfaces that protrude at the middle, by virtue of each of the side wall portions 621 of one of the outer housing walls 62 being spaced apart from a respective one of the side wall portions 621 of another one of the outer housing walls 62, the side wall portions 621 mentioned above may not block the protruding side surfaces of the sleeve body portion 51. At this time, in combination with a thickness of each of the side wall portions 621 gradually decreasing toward a center of the optical fiber connector along the length axial direction (B), an overall size of the optical fiber connector in the length axial direction (B) may be prevented from being too large.

Further referring to FIGS. 3, 4, and 5, the tail sleeve 7 includes an extending tail section 71 extending through the through groove 611 along the plug-in axial direction (A), and two stop block portions 72 protruding along the length axial direction (B) from a front end of the extending tail section 71 proximate to the insertion end of the main housing 3 and respectively received in the limiting grooves 612. The extending tail section 71 has a receiving groove 711 that recesses away from the insertion end of the main housing 3 along in the plug-in axial direction (A) and that is for receiving the rear end portion 34 and a front end of the optical fiber cable 8. The extending tail section 71 surrounds and defines a through hole 712 that communicates with the receiving groove 711 and that extends rearwardly away from the insertion end of the main housing 3 along the plug-in axial direction (A). A junction connecting the optical fiber cable 8 and the rear end portion 34 is located in the receiving groove 711, and the optical fiber cable 8 extends rearwardly away from the insertion end of the main housing 3 through the through hole 712 along the plug-in axial direction (A). Because the stop block portions 72 are respectively received in the limiting grooves 612, the tail sleeve 7 may not be rotated relative to the linking sleeve 6, so that rotation of the tail sleeve 7 is prevented, thereby preventing the optical fiber cable 8 sleeved by the tail sleeve 7 from being twisted.

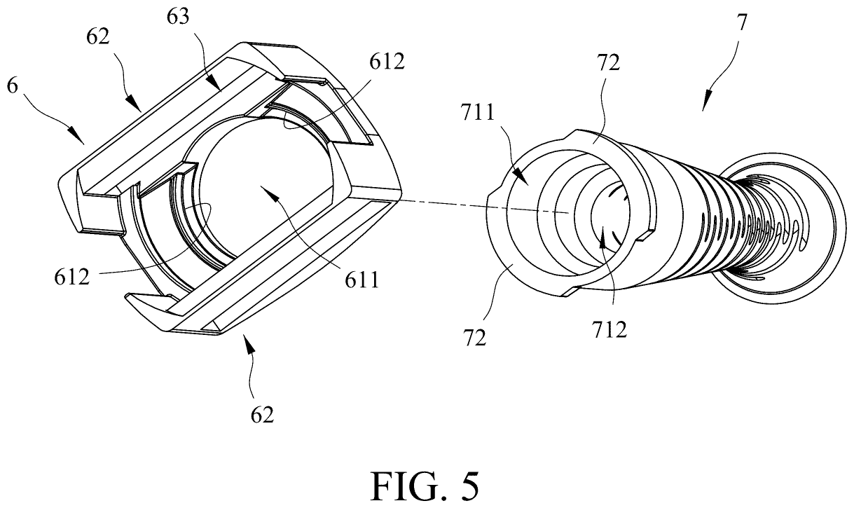

It should be noted that placement of each of the components in FIG. 5 is for convenience of illustration. In actual assembly, the linking sleeve 6 is sleeved onto the tail sleeve 7 from a rear end of the tail sleeve 7 toward the insertion end of the main housing 3 in the plug-in axial direction A. After the tail sleeve 7 is inserted through the through groove 611, the linking sleeve 6 is movable along the tail sleeve 7. During movement of the linking sleeve 6 along the tail sleeve 7, the stop block portions 72 respectively engage the limiting grooves 612 so that the linking sleeve 6 may not be moved forwardly relative to the tail sleeve 7 any further. Alternatively, apart from the aforesaid assembling method, the tail sleeve 7 may be inserted rearwardly into the through groove 611 in the plug-in axial direction (A).

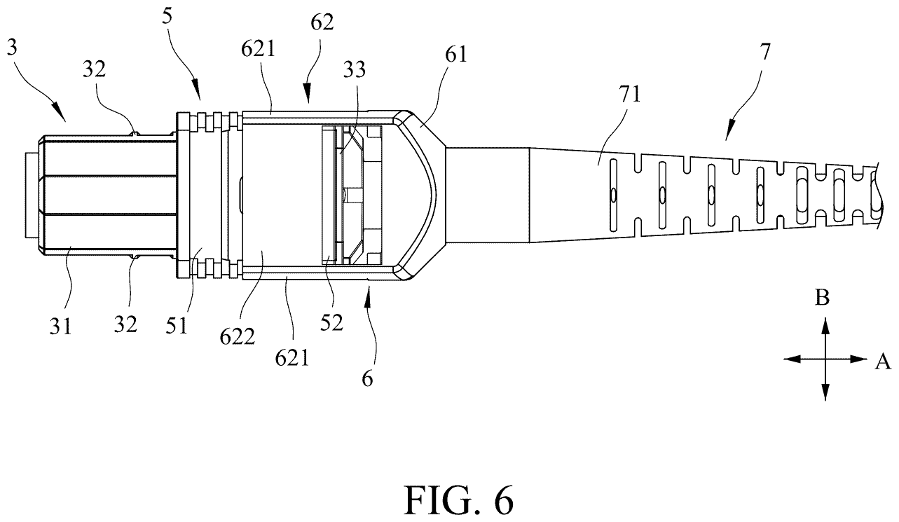

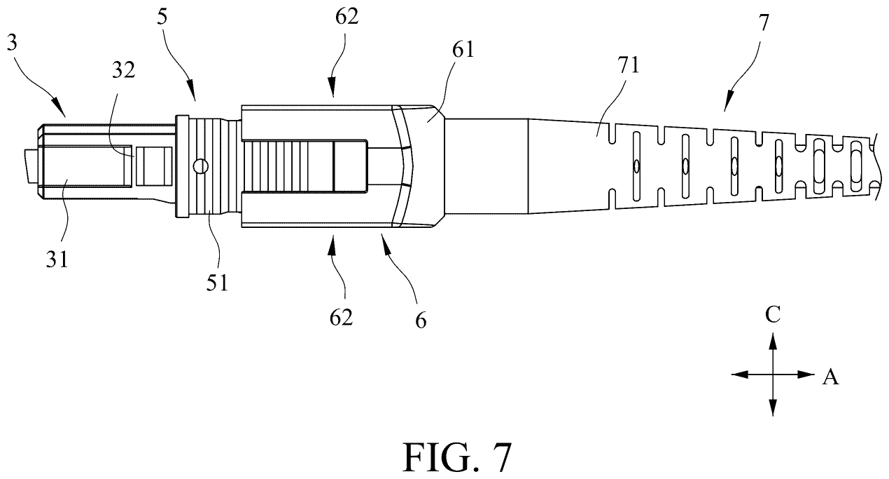

Referring to FIGS. 2, 6 and 7, the optical fiber connector may be inserted forwardly into an optical fiber adapter (not shown) along the plug-in axial direction (A). At this time, two engaging hooks (not shown) of the optical fiber adapter respectively engage the rib portions 32, and are surrounded by the sleeve body portion 51, so that the optical fiber connector is securely fixed to the optical fiber adapter. When the optical fiber connector is to be removed, a rear end of the extending tail section 71 may be pulled rearwardly so that the stop block portions 72 (see FIG. 3) drive the sleeve seat 61 to thereby simultaneously move the linking sleeve 6 rearwardly. As such, the reinforcing wall portions 622 may also push the protruding portions 52 rearwardly (to the extent that a corresponding one of the protruding portions 52 is blocked by the stopping portion 33), after which the positioning sleeve 5 is moved rearwardly relative to the housing body portion 31 along the plug-in axial direction (A). At this time, since the positioning sleeve 5 is moved rearwardly, the engaging hooks are no longer surrounded by the sleeve body portion 51, and pulling of the extending tail section 71 may be continued, thereby removing the optical fiber connector from the optical fiber adapter.

A maximum outer diameter of the tail sleeve 7 is not greater than a width of the main housing 3 in the width axial direction (C), nor is not greater than a length of the main housing 3 in the length axial direction (B). Thus, when a plurality of the optical fiber connectors are densely arranged, a distance between two adjacent ones of the tail sleeves 7 is greater than a distance between two adjacent ones of the main housings 3 or two adjacent ones of the positioning sleeves 5, so that it may be easier for a user to hold one of the tail sleeves 7 even in such a dense arrangement of the optical fiber connectors. Furthermore, because the tail sleeve 7 has a tubular shape, the user may hold the tail sleeve 7 in any direction. No matter whether the optical fiber connectors are arranged side by side in the width axial direction (C) or in the length axial direction (B), the user may hold any one of the tail sleeves 7 in the same manner for pulling the tail sleeve 7 rearwardly. The manner of holding the tail sleeve 7 does not need to be adjusted according to the directions in which the optical fiber connectors are arranged. More importantly, the linking sleeve 6 is made of a material different from a material of the tail sleeve 7. The material of the linking sleeve 6 may have greater hardness and higher strength as compared to that of the tail sleeve 7, so as to ensure that the linking sleeve 6 does not slip during movement of the positioning sleeve 5 when the linking sleeve 6 is moved rearwardly. Furthermore, the tail sleeve 7 may be made of a flexible material so that even if the tail sleeves 7 of the densely arranged optical fiber connectors are close to or even in contact with each other, the user may bend the tail sleeve 7 slightly so that the tail sleeve 7 is offset from its original position in which it is arranged, thereby expanding an operating space for the user to better apply force.

In summary, the user may directly pull the extending tail section 71 rearwardly, thereby driving the sleeve body portion 51 to move rearwardly. As such, when removing the optical fiber connector, the user does not need to hold the sleeve body portion 51, which is located closer to the front end of the main housing 3 in a tight space, the user may bend the extending tail section 71 to create more operating space. Therefore, the present embodiment of the optical fiber connector is not only quite simple and convenient to use, but also adapted to today's trend of arranging the optical fiber connectors in a dense manner, so the object of the present disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical fiber connector, comprising:
a main housing having an insertion end;
a positioning sleeve slidably sleeved on said main housing along a plug-in axial direction, said positioning sleeve including a sleeve body portion surrounding said main housing, and two protruding portions protruding outwardly from said sleeve body portion along a width axial direction that is perpendicular to the plug-in axial direction;
a linking sleeve sleeved on said positioning sleeve, and surrounding and defining two positioning slots formed along the width axial direction and respectively permitting said protruding portions to extend therein, when said linking sleeve moves away from said insertion end of said main housing in the plug-in axial direction, said positioning sleeve being driven to move away from said insertion end of said main housing; and
a tail sleeve detachably connected to a rear end of said linking sleeve distal from said insertion end of said main housing, when said tail sleeve is operated to move away from said insertion end of said main housing in the plug-in axial direction, said linking sleeve being driven to move away from said insertion end of said main housing.

2. The optical fiber connector as claimed in claim 1, wherein said linking sleeve defines a through groove extending along the plug-in axial direction, and two limiting grooves recessing away from said insertion end of said main housing in the plug-in axial direction, said limiting grooves extending from said through groove away from each other along a length axial direction perpendicular to the plug-in axial direction and the width axial direction, said tail sleeve including an extending tail section extending through said through groove along the plug-in axial direction, and two stop block portions protruding along the length axial direction from a front end of said extending tail section proximate to said insertion end of said main housing and received respectively in said limiting grooves.

3. The optical fiber connector as claimed in claim 2, wherein said linking sleeve includes a sleeve seat, and two outer housing walls spaced apart from each other in the width axial direction and extending from said sleeve seat toward said insertion end of said main housing in the plug-in axial direction, said sleeve seat and said outer housing walls cooperatively defining a sleeve space permitting said positioning sleeve to be disposed therein, said sleeve seat defining said through groove and said limiting grooves, said through groove and said limiting grooves being in spatial communication with said sleeve space.

4. The optical fiber connector as claimed in claim 3, wherein each of said outer housing walls of said linking sleeve has two side wall portions spaced apart from each other along the length axial direction and extending from said sleeve seat toward said insertion end of said main housing along the plug-in axial direction, and a reinforcing wall portion connected to said side wall portions and located at one side of a respective one of said protruding portions proximate to said insertion end of said main housing along the plug-in axial direction, said side wall portions and said reinforcing wall portion of each of said outer housing walls cooperating with said sleeve seat to define a respective one of said positioning slots.

5. The optical fiber connector as claimed in claim 4, wherein each of said side wall portions of one of said outer housing walls is spaced apart from a respective one of said side wall portions of another one of said outer housing walls in the width axial direction, said main housing including a housing body portion and a stop portion protruding outwardly in the width axial direction from a rear end of said housing body portion distal from said insertion end of said main housing, said stopping portion being disposed between one of said protruding portions of said positioning sleeve and said sleeve seat along the plug-in axial direction, and being disposed in one of said positioning slots.

6. The optical fiber connector as claimed in claim 5, wherein said main housing further has a rear end portion connected to said rear end of said housing body portion and extending away from said insertion end of said main housing along the plug-in axial direction and through said through groove, said extending tail section of said tail sleeve having an receiving groove that recesses away from said insertion end of said main housing along the plug-in axial direction and that is for receiving said rear end portion, said extending tail section surrounding and defining a through hole that communicates with said receiving groove and that extends away from said insertion end of said main housing along the plug-in axial direction, said optical fiber connector further comprising an optical fiber cable connected to said rear end portion and extending through said through hole.

7. The optical fiber connector as claimed in claim 1, wherein said linking sleeve is made of a material different from a material of said tail sleeve, and a hardness of said linking sleeve is greater than a hardness of said tail sleeve, said tail sleeve being flexible.

8. The optical fiber connector as claimed in claim 1, further comprising two springs disposed between said positioning sleeve and said main housing for storing a resilient restoring force that restores said positioning sleeve, each of said springs having two ends abutting respectively against said positioning sleeve and said main housing.
